(19) United States
(12) Patent Application Publication
(10) Pub. No.: US 2026/0002372 A1
(43) Pub. Date: Jan. 1, 2026

(54) WEIGHTED BASE FOR A MOBILE STOP DEVICE, AND MOBILE STOP DEVICE

(71) Applicant: PERI SE, Weissenhorn (DE)

(72) Inventor: Florian Sturm, Weissenhorn (DE)

(73) Assignee: PERI SE, Weissenhorn (DE)

(21) Appl. No.: 18/879,790

(22) PCT Filed: Jun. 28, 2023
(86) PCT No.: PCT/EP2023/067739

§ 371 Date: Dec. 29, 2024

(30) Foreign Application Priority Data
Jul. 1, 2022 (DE) 10 2022 116 470.5

(51) Int. Cl. E04G 21/32; A62B 35/00

(52) U.S. Cl. CPC E04G 21/3238; A62B 35/0068

(57) ABSTRACT

The invention relates to a weight base (10) for a mobile stop device (1) for securing a person at risk of falling, comprising a base body (100) with several arms (110) arranged at an angle to one another and weights (120) as a load, wherein (111) of at least one arm (110) is directly or indirectly attached at least one non-slip bearing body (130) made of an elastomer material, which has a contact surface (131) that is designed to be oblique or spherical in a tilting direction of the weight base (10).

The invention also relates to a mobile stop device (1) for a safety device with a weight base (10) according to the present invention.

The invention relates to a weight base for a mobile stop device for securing a person at risk of falling. The invention also relates to a mobile stop device with a weight base according to the present invention.

The invention is preferably used in slab formwork systems for constructing a concrete slab or slab section.

When constructing a concrete ceiling or ceiling section using a ceiling formwork system, it may be necessary for a person to work at a drop-off. This person must then be secured by means of a safety device. Safety devices are known that include a rope that is attached, on the one hand, to the person to be secured and, on the other hand, to an anchor point. Mobile stop devices are known for forming such an attachment point, which are set up freely on the work surface and secured in their position by a load.

DE 20 2011 001 953 U1 shows an example of a stop device held by a load, which has a central weight base with an attachment point for a safety rope to be attached to it. The attachment point is fixed by the dead weight of the device. A limited displacement of the device under load, i.e. in the event of a fall, is permissible or even desirable, as it can cushion the fall. In order to improve the functional safety of the ballasted stop device in the event of a fall, DE 20 2011 001 953 U1 proposes that the attachment point be connected to the weight base via an energy-absorbing element. This deforms under load, so that at least part of the fall energy or force is absorbed by the energy-absorbing element and converted into deformation energy.

The principle of a load-retained stop device is based on friction between the weight base and the surface on which the weight base or the stop device is placed. However, the friction can be reduced, which is particularly the case when the surface is damp or wet. In this case, a friction-reducing film of moisture forms between the weight base and the surface, which acts like a lubricating film. Under load, the device then starts to slide, so that the functional safety of the device is no longer guaranteed.

The present invention is therefore concerned with the object of increasing the functional safety of a load-retained mobile stop device, especially on damp or wet surfaces.

The solution of the object is the weight base with the features of claim 1 and the mobile stop device with the features of claim 13. Advantageous further developments of the invention can be found in the respective sub-claims.

### DISCLOSURE OF THE INVENTION

The weight base proposed for a mobile stop device for securing a person at risk of falling has a base body with several arms arranged at angles to each other, as well as weights as a load. At least one anti-slip bearing body made of an elastomer material is attached directly or indirectly to the underside of at least one arm, which has a contact surface that is designed to be oblique or spherical in a tilting direction of the weight base.

The proposed weight base therefore has at least one bearing body made of an elastomer material. The bearing body made of elastomer material has a damping effect because it is flexible. The elastomer material can be, for example, natural rubber. Alternatively, other elastomers such as IR, BR, SBR, EPM, EPDM can be used.

If, despite the damping effect, the weight base tips over the bearing body, for example in the event of a fall, this leads to a kind of rolling movement of the bearing body on the surface, since the bearing body has a contact surface that is slanted or spherical in the direction of tipping. If the ground is damp or wet, the moisture or wetness on the ground is displaced by the bearing body during rolling, so that a friction-reducing film of moisture does not form between the bearing body and the ground. This displacement effect significantly reduces the risk of the weight base and the stop device connected to the weight base sliding towards the edge in the event of a damp or wet surface. This increases the functional safety of the weight base and the mobile stop device.

A contact surface is described as “crowned” if it has a convex shape in at least one direction, namely in a tilting direction. The contact surface can also be only approximately crowned. This is the case, for example, if the contact surface not only has one sloping surface but several sloping surfaces that are composed in a polygon-like manner to form an approximately crowned contact surface. The wording “tilted or bulging contact surface in a tilting direction” also includes such designs.

Preferably, at least one bearing body made of an elastomer material is arranged under each arm of the base body, so that the weight base is only in contact with the ground via the bearing bodies. In this way, the damping effect can be further optimized.

Furthermore, it is proposed that not only is at least one bearing body made of an elastomer material arranged under each arm of the base body, but that this also has a contact surface that is slanted or spherical in a tilting direction. The displacement effect described above in connection with the slanted or spherical contact surface can thus be achieved in different tilting directions.

Due to the flexibility of the bearing bodies arranged under the arms of the base body, the weight base tends to tilt under load in a direction that either coincides with the longitudinal axis of an arm or with the bisector between the longitudinal axes of two adjacent arms. The number of arms and the resulting angular distances between the arms thus determine the preferred tilting directions.

The contact surface of a bearing body made of elastomer material can be designed to be oblique or spherical in one or more tilting directions. The latter is the case, for example, when the contact surface is spherically shaped. The spherical shape allows rolling in all directions. However, the spherical shape has the disadvantage that—due to the only point-shaped contact between the bearing body and the ground—the adhesion is reduced and the desired displacement effect does not occur on damp or wet ground. In this respect, at least linear contact between the bearing body and the ground is required.

In a further development of the invention, it is therefore proposed that several anti-slip bearing bodies made of an elastomer material are attached directly or indirectly to the underside of the at least one arm, the contact surfaces of which are each designed obliquely or spherically in a different tilting direction. These thus allow a rolling movement in different tilting directions. Preferably, several such non-slip bearing elements made of an elastomer material are directly or indirectly attached to the underside of all arms. The preferred number of bearing bodies, whose contact surface is designed to be oblique or spherical, is three per arm, since there are three preferred tilting directions during a tilting movement over at least one arm, namely in the direction of the longitudinal extension or the longitudinal axis of the arm and in the direction of the two angle bisectors between the longitudinal axis of the arm and the longitudinal axes of the two neighboring arms. In each of these three tilting directions, a rolling movement can then be carried out via the respective bearing body with an obliquely or convexly designed contact surface, which leads to the desired displacement effect on damp or wet ground.

According to a preferred embodiment of the invention, a plurality of bearing bodies have an elongated shape and are each shaped obliquely or spherically in the direction of their longitudinal extent. In this design of the bearing bodies, at least linear contact between the bearing bodies and the ground is ensured in order to achieve the desired displacement effect. Preferably, several elongated bearing bodies of at least one arm are arranged at an angle to each other. The angular arrangement ensures that, depending on the tilting direction, at least one bearing body has at least linear contact with the ground.

The angular distance between two bearing bodies of an arm arranged at an angle to each other preferably corresponds to half the angular distance between the longitudinal axis of the arm and the longitudinal axis of the neighboring arm. In the case of three elongated bearing bodies arranged at an angle to each other, the contact surface of the central bearing body in the longitudinal direction of the arm is preferably designed to be oblique or spherical. The contact surfaces of the other two bearing bodies are each designed obliquely or spherically in a different tilting direction.

If, for example, the base body has four arms, each of which is arranged at the same angular distance from one another, three elongated bearing bodies are preferably arranged at an angular distance of 45° from one another under each arm. The center bearing body is arranged in the center with respect to the longitudinal axis of the respective arm. If a tilting movement occurs over one arm in the direction of the longitudinal axis of the arm, the center bearing body rolls on the ground, wherein at least linear contact is ensured. If a tilting movement occurs via two arms, so that the bisector between the longitudinal axes of the two arms determines the tilting direction, the bearing bodies of the two arms, which are aligned parallel to the bisector, roll on the ground, so that at least linear contact with the ground is ensured via these two bearing bodies.

In addition to at least one bearing body with a contact surface that is slanted or convex in the direction of tipping, each arm can also have at least one further bearing body made of elastomer material, which has a flat contact surface. The flat contact surface increases the contact of the weight base with the ground, so that the weight of the weight base is distributed more evenly. The further bearing body with a flat contact surface is preferably arranged further inward with respect to the at least one bearing body with a convex contact surface. This ensures that, when the weight base tilts, the further bearing body does not hinder rolling over the bearing body with a convex contact surface. If the further bearing body with a flat contact surface is elongated, it is preferably aligned transversely to the longitudinal axis of the arm. This measure also helps to ensure that the further bearing body does not hinder the rolling over the bearing body with a crowned contact surface.

In a preferred embodiment of the invention, each arm has three bearing bodies made of elastomer material, each with a contact surface that is slanted or bulging in a tilting direction, and a further bearing body made of elastomer material with a flat contact surface, which is preferably arranged in the center with respect to the other three bearing bodies and further inward than them. This arrangement is reminiscent of a “tiger paw” when viewed from above.

In a further development of the invention, it is proposed that the underside of the at least one arm forms a plane at an angle in a tilting direction for the reception of the at least one bearing body. In this respect, the underside can be inclined over its entire length or can be angled at the end to form the slope. The slope is oriented in such a way that the distance between the arm and the ground increases towards its free end. In the area of the slope, the at least one bearing body is attached directly or indirectly to the arm so that, in the event of a fall, the slope supports the rolling of the bearing body over the arm in the event of a tilting movement via the contact surface, which is designed to be sloping or bulging in the tilting direction.

The direct attachment of the bearing bodies to the arms results in a low center of gravity of the weight base, which has a positive effect on the stability of the weight base. However, a low center of gravity does not always prove to be an advantage.

If, for example, the weight base or the mobile stop device with the weight base is to be used in the production of a prefabricated ceiling, which—before its completion—only has a thin layer of concrete and lattice girders on top as reinforcement, the weight base is preferably placed over the reinforcement on the thin concrete layer. In this respect, the center of gravity of the weight base must be raised.

As a further training measure, it is therefore proposed that spacers be arranged between the arms and the bearing bodies. With the help of these spacers, the weight base can be raised in relation to the ground, so that the reinforcement is not loaded by the weight base. This advantage is not only of benefit in the production of prefabricated floor slabs, but whenever the ground is not level.

The spacer elements are advantageously detachably attached to the arms. They can then be used as required. If no spacer elements are needed, they can be dismantled so that the advantage of a low center of gravity of the weight base comes into play again. The detachable connection can be made, for example, by means of screws or other mounting means. Similarly, the bearing bodies are preferably detachably attached to the arms either directly or indirectly via the spacer elements. These can then be removed and reattached to the spacer elements after the spacer elements have been attached to the arms.

Furthermore, it is proposed that the height of the spacer elements be adjustable. For example, spindle feet or telescopic legs can be used as spacer elements.

According to a preferred embodiment of the invention, the spacer elements are made of rectangular tubes. These are particularly easy to manufacture and have flat outer surfaces for contact with the arms and for the reception of the bearing bodies. Furthermore, the spacer elements are each releasably attached to the arms via a short side or a long side. Depending on whether the spacer elements are attached to the arms via their short side or their long side, the height of the weight base can be varied.

Furthermore, in the proposed weight base, the weights are arranged eccentrically, preferably above the bearing bodies. The eccentric arrangement leads to a favorable mass distribution, which further improves the stability of the weight base. In the event of a fall, the eccentric arrangement creates a maximally effective ballast lever arm that counteracts the tilting moment. The arrangement of the weights above the bearing bodies ensures maximum contact pressure, which also has an anti-slip effect.

The weights serving as “ballast” do not necessarily have to be arranged on the arms. In an advantageous embodiment of the invention, the weights are incorporated in the arms. Preferably, the arms of the base body for the reception of the weights are designed at least in sections to be tubular and/or hollow. The weights can thus be inserted into the arms. This ensures that the weights do not present an obstacle to safety, in particular, that they do not pose a tripping hazard.

Moving a weight pedestal usually requires an auxiliary device, for example, a lifting device and/or a crane.

In the further development of the invention, it is therefore proposed that the lower sides of the arms for the reception of a lifting device are designed in a stepped manner. The stepped design leads to a preferably centrally arranged free space between the base body and the ground, so that the lifting device can be retracted into this area.

Furthermore, it is proposed that the base body forms transport aids, for example in the form of crane lugs. The crane lugs can be designed as recesses in the base body, preferably as end recesses in the arms of the base body. In this case, each arm of the base body can be connected with a rope so that the mass of the counterweight base is evenly distributed during transportation by crane.

Alternatively or in addition, it is proposed that the base body be designed with stacking aids, for example in the form of tabs and corresponding recesses. The tabs and recesses are preferably provided on opposite sides of the base body, so that when two base bodies are stacked on top of each other, the tabs of one base body engage in the recesses of the other base body and create a form fit that prevents the two base bodies from moving relative to each other.

Preferably, the base body of a weight base according to the present invention has at least four arms. The stability increases with the number of arms, wherein four arms are sufficient. Furthermore, the arms are preferably arranged in a common plane and/or at the same angular distance from each other. The arrangement of the arms in one plane allows the weight base to be designed very flat, which favors a low center of gravity. At the same time, the top of the base body can be designed to be flat. The equal angular distance between the arms ensures that the tendency to tilt is the same for all arms.

Furthermore, the base body preferably has a center section with receptions for connecting means of an anchor element, which comprises a mast for attaching a safety device, in particular a rope. The center section and/or the center section can be designed as a separate part or as a single piece with the base body. The central arrangement of the anchor element and the mast also contributes to the tendency to tilt being the same in all directions, in particular being equally low. In addition, depending on the design of the connecting means, a detachable connection between the anchor element and the weight base can be established via the receptions in the center part. The advantage of the detachable connection is that, after removal of the anchor element, several weight bases can be stacked on top of each other, which simplifies the transportation and/or storage of the weight base.

Furthermore, a mobile stop device for a safety device is proposed, which has a weight base according to the present invention and an anchor element connected to the weight base with a mast for attaching the safety device, in particular a cable. The anchor element is preferably detachably connected to the weight base so that it can be removed if necessary, for example during transport and/or storage of the weight base. The connection is preferably made in the area of a central part of the base body of the weight base, so that the anchor element and the mast are arranged centrally with respect to the base body. The arms then form extension arms, which can optimally support the mobile stop device in the event of a crash. If the stop device tilts over at least one arm of the weight base on a damp or wet surface, the sloping or spherical design of the bearing body under the arm causes a rolling movement that displaces the moisture between the weight base and the surface. This displacement effect prevents a film of moisture from forming between the weight base and the ground, which would reduce friction and thus adhesion. Accordingly, the tendency of the mobile stop device to slip is reduced.

Since the mast of the anchor element is usually aligned vertically and arranged centrally above the weight base, a fall event quickly leads to a tilting movement of the mobile stop device. The tilting movement increases the contact pressure of the at least one bearing body on the ground, over which the rolling movement is carried out, so that the displacement effect is further increased.

The anchoring element preferably has mechanical connecting means for detachable connection to the weight base. For example, mechanical connecting means in the form of claws can be provided. Preferably, the claws are arranged in a movable manner so that they can be brought into latching engagement with recesses in the base body of the weight base.

As already mentioned, the mast is preferably arranged in the center with respect to the weight base. That means that the attachment point is located in the center above the weight base. Alternatively or in addition, it is suggested that the mast be designed as a telescopic tube. This allows for the height adjustment of the attachment point if necessary. This may be necessary, for example, if spacers are arranged on the underside of the base body so that it is raised. At the same time, the center of gravity of the weight base is raised, increasing the tendency to tip over and the tipping moment. This disadvantage can be largely compensated for by reducing the height of the pole or by lowering the attachment point.

Preferred embodiments of the invention will be explained in more detail in the following on the basis of the attached figures. These show:

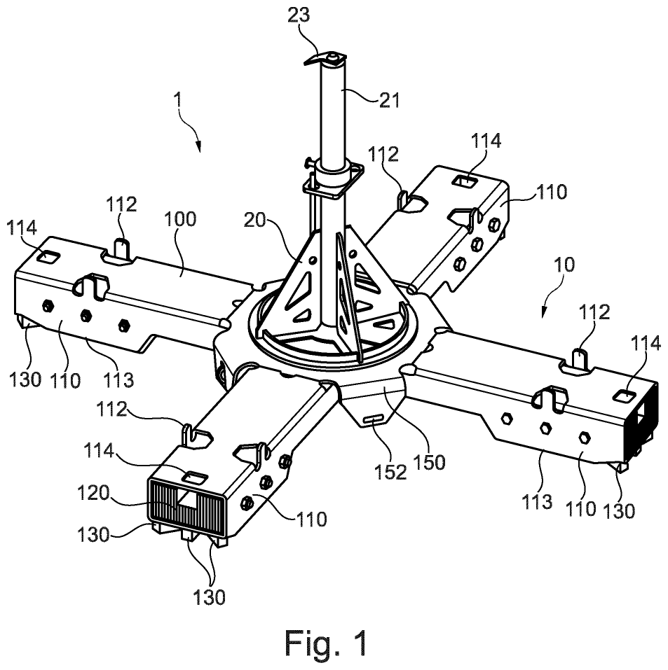

FIG. 1 a perspective view of a mobile stop device according to the present invention with an anchor element for a safety device,

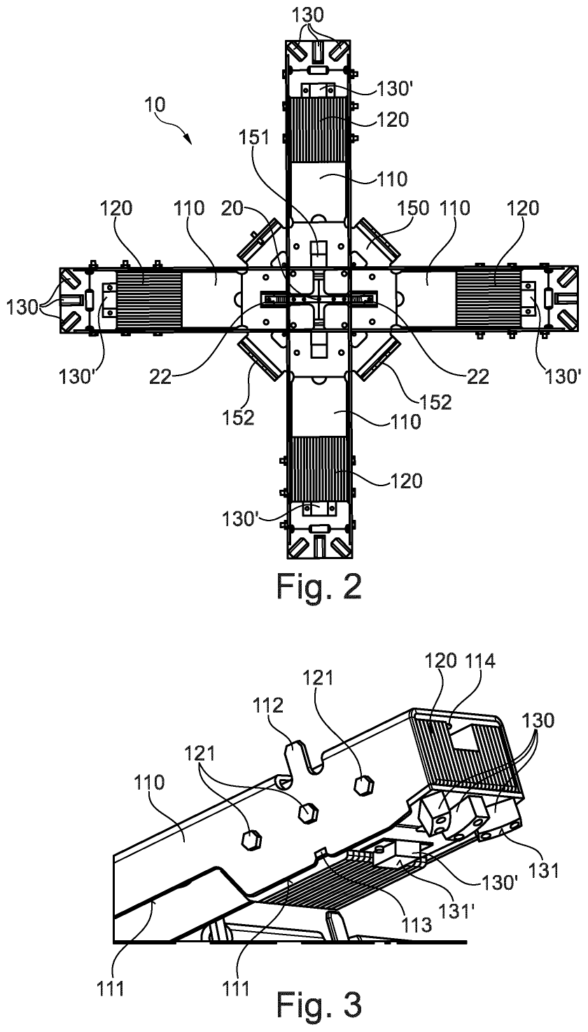

FIG. 2 a view from below of the stop device of FIG. 1 including the anchor element,

FIG. 3 a perspective view of an arm of a weight base of the stop device of FIG. 1,

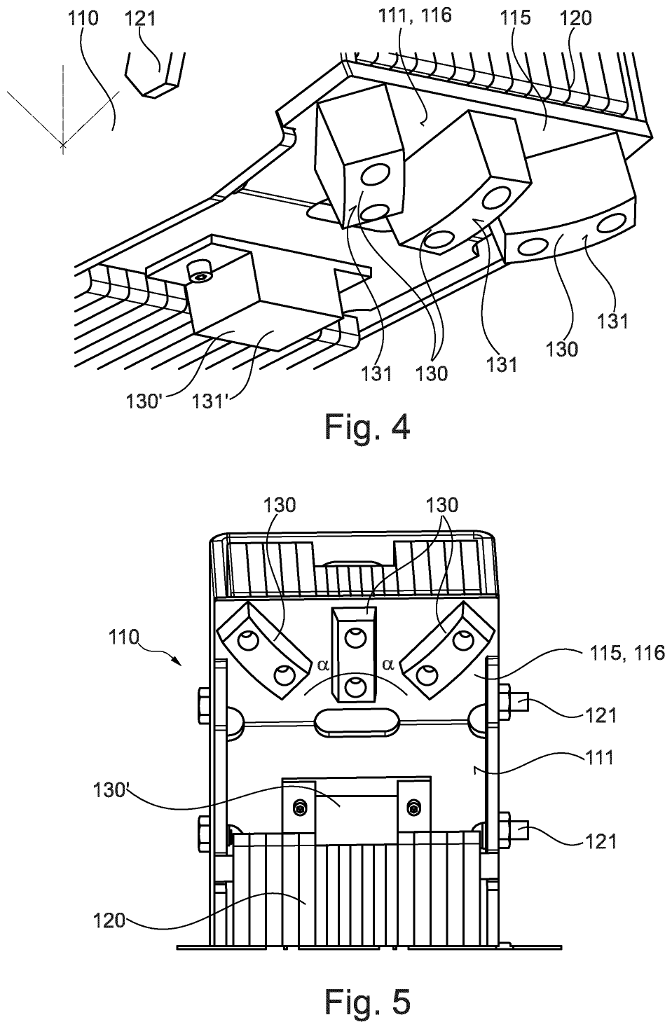

FIG. 4 an enlarged section of FIG. 3,

FIG. 5 an underside view of the arm of FIG. 3,

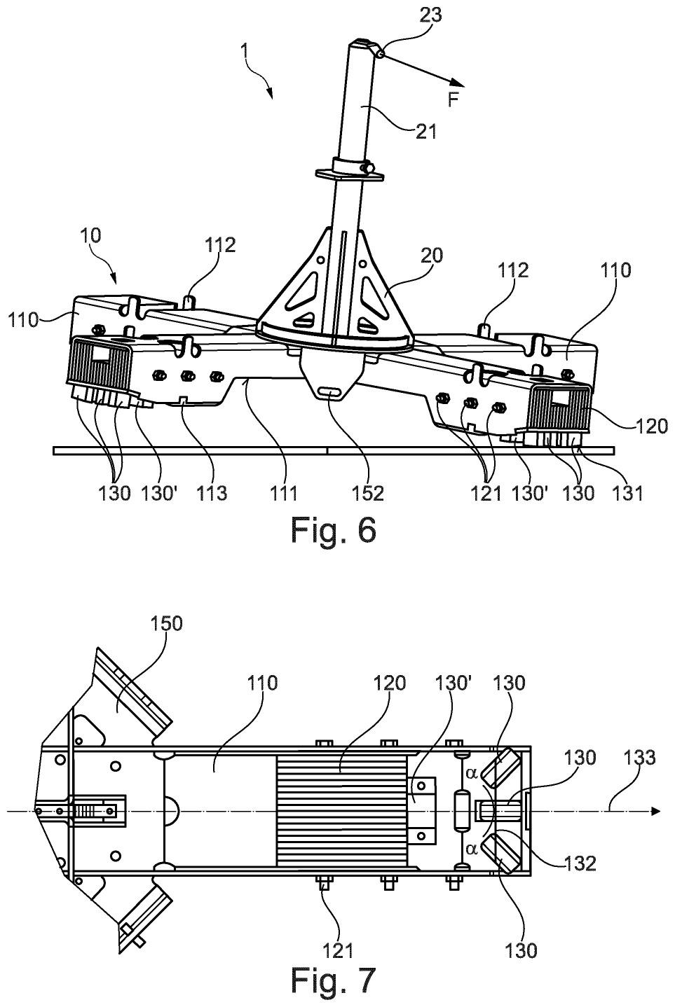

FIG. 6 a perspective view of the stop device of FIG. 1, including the anchor element during a tilting movement,

FIG. 7 a view from below of one arm of the weight base of the stop device of FIG. 1,

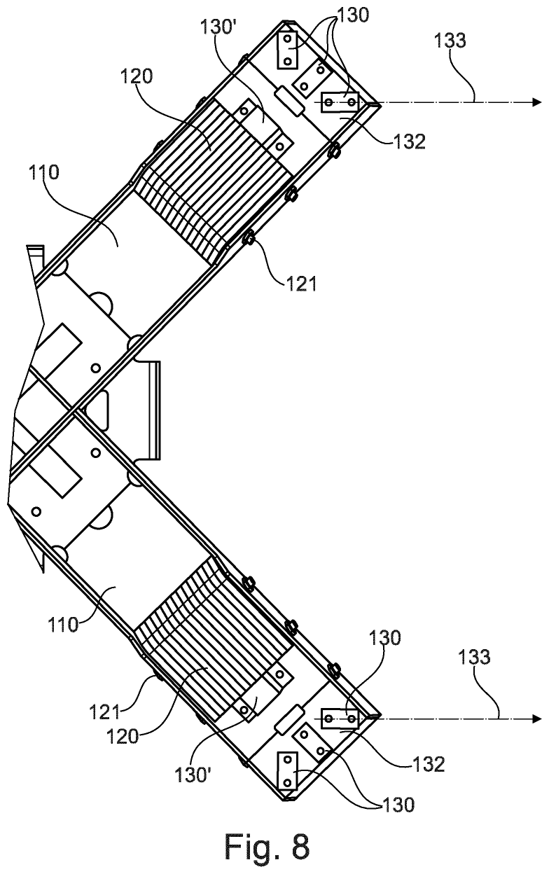

FIG. 8 a view from below of two arms of the weight base of the stop device of FIG. 1,

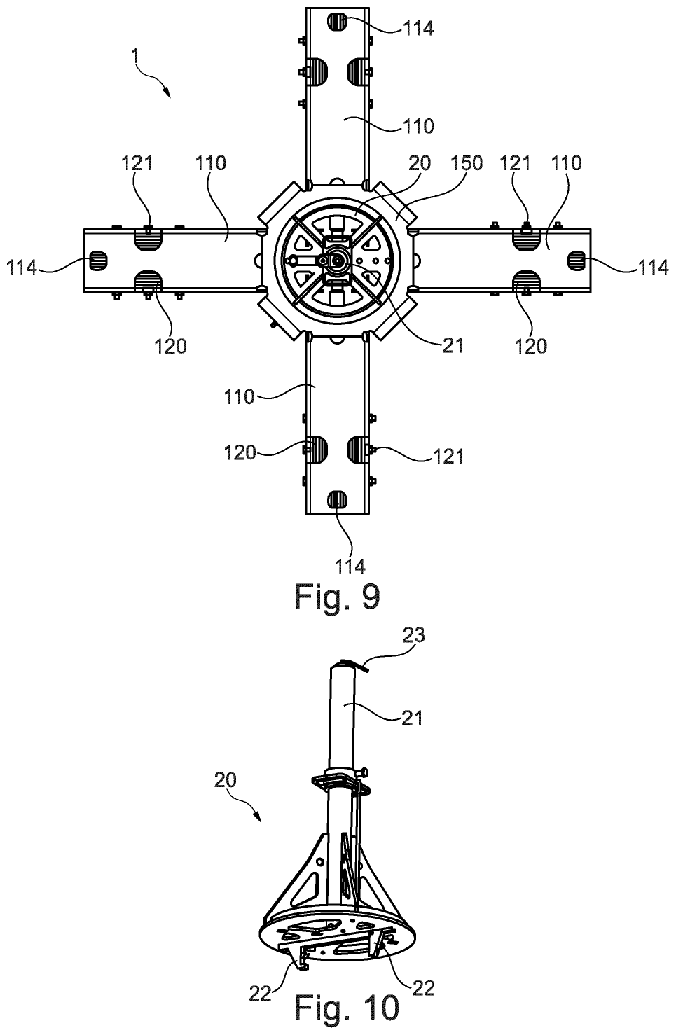

FIG. 9 a view from above of the mobile stop device of FIG. 1 including the anchor element,

FIG. 10 a perspective view of the anchor element of FIG. 1,

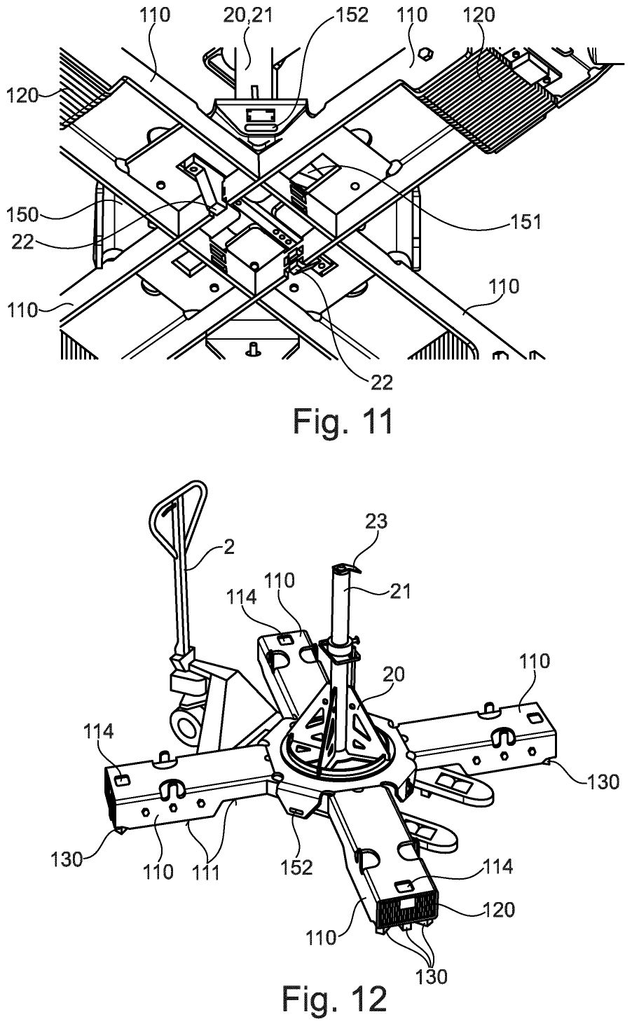

FIG. 11 a perspective view of the weight base of the stop device of FIG. 1 including the anchor element,

FIG. 12 a perspective view of the stop device of FIG. 1 including the anchor element on a lifting carriage,

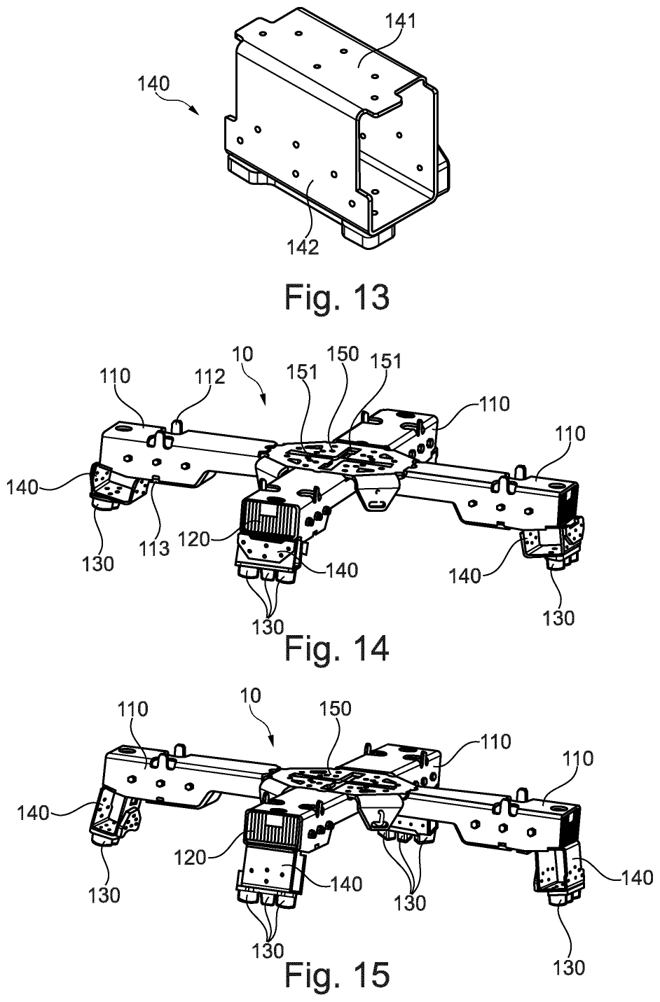

FIG. 13 a perspective view of a spacer element,

FIG. 14 a perspective view of the weight base of the stop device of FIG. 1 with spacer elements in a first preferred arrangement, and

FIG. 15 a perspective view of the weight base of the stop device of FIG. 1 with spacer elements in a second preferred arrangement.

DETAILED DESCRIPTION OF THE FIGURES

The mobile stop device 1 shown in FIG. 1 has a weight base 10 and an anchor element 20. The anchor element 20 comprises a central mast 21, on which a stop point 23 for a safety device, in particular for a cable, is formed. At the other end, the anchor element 20 has connecting means 22, via which the anchor element 20 is detachably connected to the weight base 10.

The weight base 10 has a base body 100 with four arms 110 as extension arms. The arms 110 are designed to be tubular and/or hollow in their end sections, i.e. at their free ends, for the reception of weights 120. The weights 120 are integrated into the arms 110 in the area of the end sections. This results in an eccentric arrangement of the weights 120 and consequently in a particularly favorable mass distribution.

The base body 100 is mounted on bearing bodies 130 made of an elastomer material that has an anti-slip effect. The bearing bodies 130 are each arranged under the arms 110 at their free ends, so that the load of the weights 120 rests on the bearing bodies 130. The upper sides of the arms 110 have recesses which, together with recesses in the weights 120, form crane lugs 114. The weight base 10 or the mobile stop device 1 can be connected to a 4-strand crane sling in the area of the crane lugs 114. On the upper side, the arms 110 also form lugs 112 that serve as stacking aids. When weight bases 10 are stacked on top of each other, the lugs 112 of the lower weight base 10 engage in corresponding recesses 113 of the weight base 10 located above. This prevents the weight bases 10 from moving relative to one another.

The arms 110 of the weight base 10 shown in FIG. 1 converge in a central part 150 which has receptions 151 for the connecting means 22 of the anchor element 20 for the releasable connection to the base body 100. The connecting means 22 are in the form of claws that can be inserted into the receptions 151 and brought into latching engagement with the base body 100 (see FIGS. 2, 10 and 11). The center part 150 also forms four clamping belt receptacles 152, which are each arranged laterally on the center part 150 between two arms 110.

The weights 120 received in the arms 110 are designed in the form of plates, wherein a plurality of plate-shaped weights 120 each form a plate pack received in an arm 110. The individual plate-shaped weights 120 are arranged in an upright position. The weights 120 can thus be inserted individually or as a plate pack into the tubular and/or hollow end sections of the arms 110. Insertion preferably takes place from the inside outwards, since—as can be seen in particular from FIGS. 3, 4 and 5—the arms 110 have undersides 111 that run at an angle towards the end or form surfaces 116 that run at an angle. In the present case, the sloping surfaces 116 are formed by angled base plates 115. Each base plate 115 also forms a stop 122 for the plate-shaped weights 120, so that the end position of the weights 120 is predetermined by the stop 122. This makes it easier to insert the bolts 121, by means of which the weights 120 are fixed in the arms 110. Since the weights 120 are held upright in the arms 110, the screw bolts 121 can be arranged transversely in this respect, so that their heads and nuts screwed on at the other end come to rest in each case on the side of the arms 110.

The bearing bodies 130 are also arranged in the area of the angled base plates 115. As can be seen in particular from FIGS. 2, 3, 4 and 5, a plurality of bearing bodies 130 are arranged on the underside 111 of each arm 110. These are each elongated and arranged at an angle to one another. In the area of the inclined surface 116, each arm 110 has three bearing bodies 130. A first bearing body 130 is arranged in each case in the center under the arm 110 and oriented in the longitudinal direction of the arm 110. The central bearing body 130 is flanked by two further bearing bodies 130, which are each arranged at the same angular distance α to the first bearing body 130. The angular distance α—measured between the longitudinal axes of the bearing bodies 130—is 45° in the present case (see in particular FIG. 5). The three bearing bodies 130 each have a contact surface 131 that is convex in the longitudinal direction of the bearing bodies 130 (see in particular FIG. 4). Outside the oblique surface 116, a further bearing body 130′ is attached to the floor panel 115, which is aligned transversely to the longitudinal direction of the arm 110 and has a flat contact surface 131′ (see in particular FIG. 4).

In the event of a crash, a tensile force F acts on the attachment point 23, causing a tilting moment so that the weight base 10 performs a tilting movement (see FIG. 6). The weight base 10 then rolls over at least one bearing body 130 with a convex contact surface 131, since the contact surface 131 of the bearing body 130 is convex in the respective tilting direction 133. When the ground is damp or wet, this rolling motion causes a displacement effect that prevents the formation of a friction-reducing film of moisture between the bearing body 130 and the ground. This reduces the risk of the weight pedestal 10 slipping on a film of moisture towards the fall edge. The arrangement of the bearing bodies 130 in the area of the sloping surfaces 116 further enhances the displacement effect, since a maximum rolling distance is achieved for a given size of the bearing bodies.

As exemplarily shown in FIGS. 7 and 8, the weight pedestal 10 has preferred tilting directions 133. It tilts either over one arm 110 (FIG. 7) or over two arms 110 (FIG. 8).

If it tilts over one arm 110 (FIG. 7), it rolls over the centrally arranged bearing body 130 of this arm 110, since the contact surface 131 of the central bearing body 130 is convex in the longitudinal direction of the arm 110 and thus in the tilting direction 133. The elongated shape of the bearing body 130 ensures that the contact between the bearing body 130 and the ground is at least linear, so that the desired displacement effect is achieved. The linear contact is indicated in FIG. 7 by a line 132.

If the base 10 tilts over two arms 110 (FIG. 8), it rolls over two bearing bodies 130, which are arranged on the outside of the two arms 110 and each have a bulging contact surface 131 in the tilting direction 133. In this case, too, the elongated shape of the bearing bodies 130 ensures that at least linear contact with the ground is maintained, which is needed to achieve the displacement effect. The linear contact is indicated by lines 132 in FIG. 8.

Due to the elasticity of the bearing bodies, they deform under load. It can therefore be assumed that, when rolling, there is not only linear but also surface contact between the respective bearing body or the respective bearing bodies and the ground.

As long as the weight base 10 does not tilt, it essentially rests on the four bearing bodies 130′, whose contact surfaces 131′ are flat.

FIG. 9 shows the mobile stop device 1 in a plan view. The anchor element 20 is detachably connected to the weight base 10 via the center section 150 of the base body 100. The detachable connection is established by the connecting means 22, which form claws (see in particular FIG. 10). The claws are inserted into the receptions 151 of the center part 150 and then brought into locking engagement with the base body 100 (see in particular FIG. 11). In this respect, one claw is designed to be movable, in particular to be pivotable (see in particular FIG. 10).

As can also be seen from FIG. 11, the undersides 111 of the arms 110 are designed in a stepped manner, so that the distance of the base body 100 to the ground is greater further inwards than in the area of the end sections of the arms 110 that receive the weights 120. This free space can be used for the reception of a lifting device 2, as shown in FIG. 12. With the help of the lifting device 2, the weight base 10 or the mobile stop device 1 can be easily moved.

The weight base 10 shown has a low height, so that its center of gravity is low. The low center of gravity results in a favorable mass distribution, so that the weight base 10 has a high stability. In order to be able to use the weight base 10 on uneven surfaces and/or when manufacturing prefabricated floor slabs with a thin layer of concrete and steel mesh reinforcement on top of it, the weight base 10 can be combined with spacer elements 140. These are attached to the undersides 111 of the arms 110 so that the weight base 10 is raised. The base body 100 then comes to rest above the reinforcement.

FIG. 13 shows an example of a spacer element 140 that is made of a rectangular tube and has a short side 141 and a long side 142. For height adjustment, the spacer element 140 can optionally be connected to an arm 110 of the base body 100 via its long side 142 (see FIG. 14) or via its short side 141 (see FIG. 15).

The fastening of the spacer elements 140 to the base body 100 can be done by means of screws, so that the fastening is detachable. The obliquely running surface 116 of the angled base plate 115 preferably serves as the contact surface. If bearing bodies 130 are arranged there, these are dismantled beforehand. The dismantled bearing bodies 130 can then be attached to the spacer elements 140, so that they are indirectly attached to the arms 110 of the weight base 10 via the spacer elements 140. In this way, the displacement effect caused by the bearing bodies 130 can continue to be used.

### REFERENCE LIST

1 stop device
2 lifting device
10 weight base
20 anchor element
21 mast
22 lifting gear
23 attachment point
100 base body
110 arm
111 underside
112 tab
113 recess
114 crane lug
115 bottom plate
116 surface
120 weight
121 screw bolt
122 stop
130 bearing body
131 contact area
132 line
133 tilting direction
140 spacer
141 short side
142 long side
150 center section
151 reception
152 tensioning belt reception

1. A weight base (10) for a mobile stop device (1) for securing a person at risk of falling, having a base body (100) with a plurality of arms (110) arranged at an angle to one another and weights (120) as a load, wherein at least one anti-slip bearing body (130) made of an elastomer material is directly or indirectly attached to an underside (at least one arm (110), at least one non-slip bearing body (130) made of an elastomer material is directly or indirectly attached, which has a standing surface (131) that is designed to be slanted or rounded in a tilting direction of the weight base (10).

2. The weight base (10) according to claim 1,
characterized in that a plurality of anti-slip bearing bodies (130) made of an elastomer material are directly or indirectly attached to the underside (111) of the at least one arm (110), the bearing surfaces (131) of which are each designed to be oblique or spherical in a different tilting direction.

3. The weight base (10) according to claim 1 or 2,
characterized in that a plurality of bearing bodies (130) have an elongated shape and are each shaped obliquely or spherically in the direction of their longitudinal extent, wherein a plurality of elongated bearing bodies (130) of at least one arm (110) are preferably arranged at an angle to one another.

4. The weight base (10) according to any one of the preceding claims, characterized in that the underside (111) of the at least one arm (110) forms at the end a plane running obliquely in a tilting direction for the reception of the at least one bearing body (130).

5. The weight base (10) according to any one of the preceding claims, characterized in that spacer elements (140) are arranged between the arms (110) and the bearing bodies (130), which are preferably releasably attached to the arms (110) and/or are height-adjustable.

6. The weight base (10) according to claim 5,
characterized in that the spacer elements (140) are made of rectangular tubes, which are preferably each detachably fastened to the arms (110) via a short side (141) or a long side (142).

7. The weight base (10) according to any one of the preceding claims, characterized in that the weights (120) are arranged eccentrically, preferably above the bearing bodies (130).

8. The weight base (10) according to any one of the preceding claims, characterized in that the arms (110) for the reception of the weights (120) are designed to be tubular and/or as hollow bodies, at least in sections.

9. The weight base (10) according to any one of the preceding claims, characterized in that the lower sides (111) of the arms (110) are designed to be stepped for the reception of a lifting device (2).

10. The weight base (10) according to any one of the preceding claims, characterized in that the base body (100) forms transport aids, for example in the form of crane lugs (114), and/or stacking aids, for example in the form of tabs (112) and corresponding recesses (113).

11. The weight base (10) according to any one of the preceding claims, characterized in that the base body (100) has at least four arms (110) which are preferably arranged lying in a common plane and/or at the same angular distance from one another.

12. The weight base (10) according to any one of the preceding claims, characterized in that the base body (100) has a center part (150) with receptions (151) for connecting means (22) of an anchor element (20) which comprises a mast (21) for attaching a safety device, in particular a cable.

13. A mobile stop device (1) for a safety device, comprising a weighted base (10) according to any one of the preceding claims, and an anchor element (20) which is connected, preferably releasably connected, to the weighted base (10) and has a mast (21) for attaching the safety device, in particular a rope.

14. The stop device (1) according to claim 13,
characterized in that the anchor element (20) has mechanical connecting means (22), for example in the form of claws, for releasable connection to the weight base (10).

15. The stop device (1) according to claim 13 or 14,
characterized in that the mast (21) is arranged centrally with respect to the weight base (10) and/or is designed as a telescopic tube.
